(19) United States
(12) Patent Application Publication
(10) Pub. No.: US 2004/0034573 A1
(43) Pub. Date: Feb. 19, 2004

(54) Method and system for managing home shopper data

(76) Inventor: Robb A. Cohen, McLean, VA (US)

Correspondence Address: DICKSTEIN SHAPIRO MORIN & OSHINSKY LLP, 2101 L STREET NW, WASHINGTON, DC, 20037-1526, US

(21) Appl. No.: 10/443,067

(22) Filed: May 22, 2003

Related U.S. Application Data
(60) Provisional application No. 60/382,027, filed on May 22, 2002.

(51) Int. Cl. G06F 17/60

(52) U.S. Cl. 705/26

(57) ABSTRACT

A computerized home shopper registration system is provided that enables the use of standardized questions during a home shopper's registration. Further, a computerized data management system is provided that allows more efficient use of information collected from home shopper.

### FIELD OF THE INVENTION

The present invention relates to data management systems, and, more particularly to home shopper data management systems and methods.

### BACKGROUND OF THE INVENTION

The management of sellers and prospective buyers in a product market can be difficult. The Home Building industry, and more particularly, home builders (i.e., the product sellers) collect information on a prospective home shopper (i.e., prospective buyers) when the home shopper visits a home builder's sales office or model homes and registers. The registration process provides a home builder with information that is used to assist the home builder in selling the home shopper a home. The home shopper's collected information is intended to be used as a qualification of the home shopper; second, as an assessment of the home shopper's needs; and, third, to assist the home builder in following up on the home shopper and planning future developments. To best assess the home shopper's needs, and consequently the home builder's ability to meet those needs, several relevant factors are typically sought: the home shopper's income; the home shopper's anticipated home purchase price (or range of prices); the home shopper's urgency to purchase a home; and any contingency that may prevent the home shopper from purchasing a home. The registration information also provides the home builder, or more typically, a sales representative of the home builder, the ability to contact the home shopper in the future, either to follow up on the home shopper's current visit or for future sales, e.g., a lead. The registration information may also serve the home builder's corporate planning department by providing a home shopper's market demand (e.g., home features and pricing).

Historically, the registration process has several problems. One problem is the lack of standardization in the data collected during the registration process from potential home shoppers. For example, a home shopper registering at one location of a home builder's sales office or model home site may be asked different questions than when the home shopper is at a different sales office or different model home site, even though it is the same builder. This lack of standardization can result in inaccurate and incomplete information about the home shopper and therefore provide unreliable data for use in current or future modeling.

Another problem with the registration process is the inaccuracy that occurs when a home shopper does not consistently and accurately complete the registration process. For example, a home shopper who is visits several sales' offices or model home sites may not consistently complete the registration. Further, the home shopper may not register at every sales office location or home site. A home shopper may fail to complete the registration process due to registration fatigue, i.e., that the registration process has become too tedious or demanding for the home shopper. The incidence of registration fatigue generally correlated to the number of visits by a home shopper to a home site or a sales office, the more places visited, the more likely the incidence of fatigue. Not only does registration fatigue affect the accuracy of the home shopper's visit, but it also prevents the home builder who was visited by the home shopper at the end of a day to benefit from the more comprehensive, complete, and accurate data on the home shopper that the first home builder visited by the home shopper on that day.

From a home builder's perspective, the more information that is known about a home shopper, the easier and the greater the potential that a sale can be made. Conversely, the less the home builder knows about a home shopper, the more difficult it is for the home builder to close a deal with a home shopper. The home builder's lack of knowledge about a home shopper results in higher lead processing cost for the home builder as well as a longer sales cycle.

Since potential sales stem from home shoppers, it is important for home builders to have the ability to follow up the home shopper's visit with additional communication with the home shopper. The more contact information (e.g., a phone number, email, or mailing address) that a home builder has about a home shopper, the easier it is for the home builder to follow-up (e.g., thank you letter, email, phone call). Conversely, the less information that a home builder has about a home shopper, the harder it is for the home builder to follow-up. This follow up is particularly difficult if the home builder lacks essential home shopper information.

Potential sales often depend on leads that are derived from prior visits from home shoppers. Generally, leads become less likely to purchase a home as time passes, i.e., the leads become cold. Thus, it is important that leads are followed while they are hot.

In conventional home builder management systems, home shoppers' visits are registered on paper. Assuming that a home shopper's fatigue does not set in and that the home shopper has consistently completed the registration process at each sales office or home site visited, the management of the paper registration information can be difficult. This management is particularly difficult if a home builder has multiple sales offices and home sites. The more time required to process these leads, the colder the leads get. This potential mismanagement of information can result in a home builder losing valuable leads that could have been a potential sale and therefore increase income.

Additionally, the potential home shoppers' information can be valuable for the home builder's future plans. The information can be analyzed and used to develop new products or future properties. For example, a home builder may analyze a home shopper's response to home model sizes and features to build future homes.

Therefore, it would be desirable to have a computerized home shopper registration system that enables the use of standardized questions during a home shopper's registration. Further, it would be desirable to have a home shopper only need to register in a management system once, but have the home shopper's data available at different locations. It would also be desirable to have computerized home shopper data management system that allows more efficient use of information collected from home shoppers.

### BRIEF SUMMARY OF THE INVENTION

A system is provided that manages home shopper information. By computerizing the home shopper's initialization registration and making that information available at different locations within the system, a home shopper is only required to register once, yet visit many locations and have the system keep track of the different visits. The system also provides and maintains the registration information entered by the home shopper and the locations that the home shopper visits. Using the information entered by the home shopper, the system rates the home shopper in terms of his likelihood to purchase a home from a home builder, i.e., the program qualifies the type of prospect of

The system also provides tools to facilitate a home builder's management of sales and future development. In one aspect, a data collection tool is provided to gather home shopper information from non-system computer systems. In another aspect, analysis reporting tools are provided that permit the home builder to examine different relationships between data.

A method is provided for managing a home shopper system that includes the steps of: accessing a central computer of a home shopper management system via a remote terminal; registering in the home shopper management system by using the remote computer to respond to a plurality of questions; submitting a plurality of responses to the plurality of questions; and storing the plurality of responses to the plurality of questions as a record of a home shopper.

Another method is provided for managing a home shopper system that includes the steps of: accessing a central computer of a home shopper management system via a remote terminal; retrieving a home shopper journal of a home shopper; viewing the home shopper journal; and storing the home shopper journal.

Another method is provided for managing a home shopper system that includes the steps of: collecting home shopper information from a non home shopper management system computer, wherein a home shopper management system computer communicates with the non home shopper management system to transfer the home shopper information to the home shopper management system computer.

Another method is provided for managing a home shopper system that includes the steps of: retrieving a record of a home shopper, by a home shopper management system computer; and rating the home shopper based on an answer in the record of the home shopper.

Another method is provided for managing a home shopper system that includes the steps of: retrieving a record of a home shopper from a home shopper management system computer; determining if a task should be done by a home builder wherein the task is based upon the record of a home shopper; and providing the task to the home builder.

Another method is provided for managing a home shopper system that includes the steps of: retrieving a record of a home shopper from a home shopper management system computer; and displaying the record of the home shopper.

Another method is provided for managing a home shopper system that includes the steps of: retrieving a plurality of records of home shoppers from a home shopper management system computer; and preparing a report from the plurality of records based on a pre-defined filtering parameter.

### BRIEF DESCRIPTION OF THE DRAWINGS

These and other features and advantages of the invention will be more readily understood from the following detailed description of the invention which is provided in connection with the accompanying drawings, in which:

FIG. 1 depicts a schematic diagram of the home shopper management system, in accordance with an exemplary embodiment of the present invention;

FIG. 2 shows various methods that a home shopper can use to register with the system;

FIG. 3 shows a home shopper's shopper journal;

FIG. 4 shows an exemplary computer screen display of a home builder viewing recent home shopper visitors;

FIG. 5 shows a report generated from a predefined Hotsheet, where the analysis is focused on the occupation of the home shopper as it corresponds to different home sites of the home builder.

FIG. 6 shows a report generated from a predefined Hotsheet, where the analysis is focused on the age of the home shopper as it corresponds to different home sites of the home builder;

FIG. 7 shows a report generated from a predefined Hotsheet, where the analysis is focused on the income of the home shopper as it corresponds to different home sites of the home builder;

FIG. 8 shows a report generated from a predefined Hotsheet, where the analysis is focused on the income of the home shopper as it corresponds to different home sites of the home builder;

FIG. 9 shows a report generated from a predefined Hotsheet, where the analysis is focused on the previous residence of the home shopper as it corresponds to different home sites of the home builder; and

FIG. 10 shows a report generated from a predefined Hotsheet, where the analysis is focused on the previous residence of the home shopper as it corresponds to different home sites in different counties of the home builder.

### DETAILED DESCRIPTION OF THE INVENTION

In the following detailed description, reference is made to the accompanying drawings, which form a part hereof, and in which is shown by way of illustration specific embodiments in which the invention may be practiced. These embodiments are described in sufficient detail to enable those of ordinary skill in the art to make and use the invention, and it is to be understood that structural, logical, or procedural changes may be made to the specific embodiments disclosed without departing from the spirit and scope of the present invention.

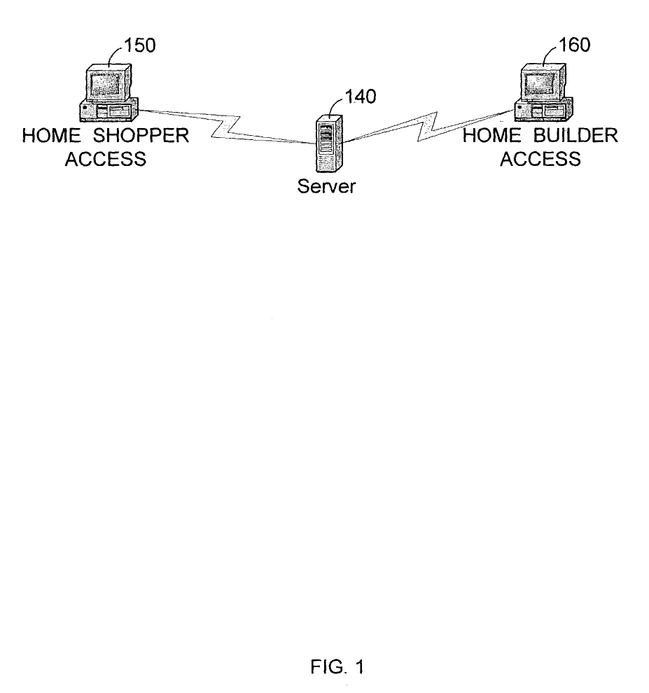

FIG. 1 depicts a schematic diagram of the home shopper management system, in accordance with an exemplary embodiment of the present invention. As seen in FIG. 1, home shopper management system 100 includes a computer system 140, a home shopper network terminal 150, and a home builder network terminal 160. The home shopper management system tracks home shoppers who visit the system. A home shopper visit is, for example, when a home shopper registers, or re-registers, and the home shopper's current interest in a home, a home builder, a home builder's development, or a community, is recorded. In a preferred embodiment, a record is created for each home shopper. A home shopper record is the collection of the home shopper's information. The fields of the record include, for example, the answers to the registration questions, home site or sales office visit information (e.g., date, identification of which site or office, identification of home builder or community), home shopper ratings based on different pre-defined characteristics, personal notes of the home shopper, notes of the home builder, evaluation of the home shopper by the home builder, and activity history. Information in some fields may only be viewed by the home shopper or the home builder.

After a home shopper registers in the home shopper management system and the information is stored in the home shopper management system, the home shopper management system generates and sends a response to the shopper (e.g., thanking the home shopper for visiting) and to the home builder. (indicating that a home shopper has visited and has expressed an interest in home that they sell) (The home shopper management system may include more than one home builder, however, for the purposes of the description, home builder refers to the entity that builds/sells the home that the home shopper has expressed an interest in). If a home shopper subsequently visits a home builder's home site or sales office (or “visits” the home builder through the Internet), then the home shopper does not need to completely register again, but only re-registers. A home shopper re-registers by providing identifying information and the prior entered home shopper's record is accessed and the record information is updated reflecting the current visit. When the updated home shopper record is saved in the home shopper management system after the changes, the home shopper management system notifies the home shopper and home builder, as described above.

After a home shopper's initial registration, the home builder can access the home shopper's record and responses. For example, the home builder uses the information to communicate further with the home shopper. Or, the home builder analyzes records from several different home shoppers for management and future planning purposes. For example, based on the analysis the home builder may incorporate particular home features into future homes, or, different levels of management utilize the tools to track employee work flow.

The computer system 140 is a central computer system, network server, or other similar processing device, that stores and executes the home shopper management program (not shown). The computer system 140 stores data generated by the home shopper management program. The computer system 140 is connected to the Internet and is thereby able to communicate with other systems likewise connected to the Internet. In a preferred embodiment, the computer system 140 is an Internet hosting computer system, where the home shopper management program resides on the Internet hosting system.

The home shopper network terminal 150 is a computer system or other similar processing device that provides a home shopper access to, and use, of the Internet. Although shown as one device in FIG. 1, the home shopper network terminal 150 is representational of any of number and type of conventional devices that permit a home shopper access to the home shopper management program. As described in greater detail below, the home shopper will use the home shopper management program to perform a variety of home shopping functions.

The home builder network terminal 160 is a computer system, or other similar processing device, that provides a home builder, or any member of the home builder's organization (collectively referred to as “home builder”), access to, and use, of the Internet. Many different individuals from the home builder's company may access the home shopper management program. For example, sales persons, sales management, and differing layers of corporate management may have access. Although shown as one device in FIG. 1, the home builder network terminal 160 is also representative of any number and type of conventional devices that permit a home builder access to the home shopper management program. As described in greater detail below, the home builder can use the home shopper management program to perform a variety of home shopper management functions.

A home shopper enters the home shopper management system 100 through a registration process. During registration, the home shopper provides information about himself and his home shopping interests. The number of home shoppers part of the home shopper management system is only to be limited by the particular use of the home shopper management system. A home shopper only has access to his own entered and stored information. The home shopper's information is stored in the home shopper management system 100.

Further, a home builder enters the home shopper management system 100 through a registration process. As part of the registration, the home builder describes his organization (e.g., employees, structure, etc.) and provides information about the homes that he sells. A home builder can access his own information. Further, a home builder can access the record of a home shopper who visits a homes site or sales office of the home builder, as well as a home shopper who “visits” the builder electronically via the Internet. The number of home builders and information about a home builder's organization and home information is only limited by the particular use of the home shopper management system.

The home shopper management system 100 provides several features to facilitate the home shopper during his home shopping experience, for example: an automated, standardized registration and a shopper's journal. Further, the home shopper management system 100 provides several features to facilitate the home builder selling homes, for example: a rating system for a home shopper, an electronic lead (“e-leads”) collection process, a contact management module, and a data analysis product (“hotsheets”).

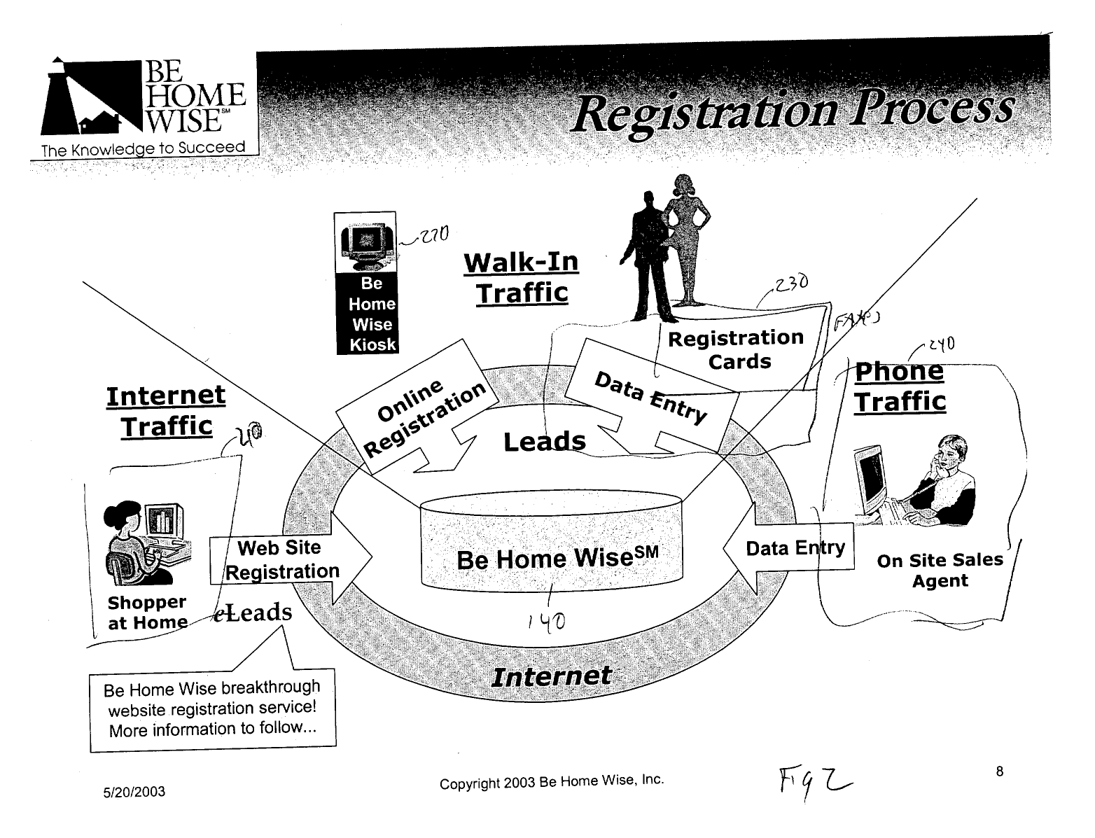

A standardized registration for a home shopper is provided in accordance with a preferable embodiment of the invention. FIG. 2 shows various methods that a home shopper can use to register with the system. As seen in FIG. 2, a home shopper can register as part of the home shopper management system in several different ways: through a home shopper network terminal 210, a kiosk 220, a registration card/data entry system 230, or phone traffic/data entry 240.

A home shopper may register using a private computer that has access to the Internet, e.g., home shopper network terminal 210. Alternatively, a home shopper may register using a computer at a home builder's sales office or home site, e.g., kiosk 220. The home builder may provide a stand alone computer kiosk that enables a home shopper to perform registration on-site. Additionally, the home shopper may complete a registration card and the registration data is entered into the home shopper management system computer program by a data entry person. Also, the home shopper may communicate with a member of the home builder's staff who enters the information into the home shopper management system computer program. In a preferred embodiment, a home shopper enters into the home shopper management system 100 (FIG. 1) and registers through the use of a home shopper network terminal 210 or a kiosk 220, which accesses a registration program on the home shopper management program.

As part of the registration process, the home shopper management system 100 gathers information from the home shopper, e.g., a home shopper enters information about himself and his home buying interests. For example, in response to questions, a home shopper will enter basic biographical information, e.g., age and marital status; occupational information, e.g., occupation, salary, and distance to work (from a desired home site); present housing situation, e.g., own/rent, type of current residence, and reason for shopping for a new home; and home shopping information, e.g., desired number of bedrooms, bathroom, and layout. The home shopper can indicate the desired home builder's community that he intends to visit, learn more about, or is interested in purchasing. The answers to these questions are submitted to and stored in the home shopper management computer system 140.

The home shopper's registration information is used by the home builder for future sales. The information also is used for future home development planning. Finally, this information is used by the home builder for administrative management and tasking.

The registration questions are designed to be simple and informative. By having a small number of straight forward, illustrative questions, a home shopper imparts information in a short time frame. By minimizing the number of questions that a home shopper must respond to, the tediousness of completing the registration is also minimized. The registration questions are standardized. Thus, in an exemplary embodiment, the questions that are required as part of the registration process are the same, regardless of how the data is entered into the home shopper management program. Further, the questions are the same regardless of which community or home builder is visited. Thus, there is a consistency in type of data collected from home shoppers.

The computerized registration process reduces the incidence of “registration fatigue” by providing “automated registering” (i.e., re-registering). A home shopper's previously entered registration information is retrieved from the home shopper management system 100 by using identifying information about the home shopper. For example, after a home shopper initially registers, the home shopper may visit a home builder's home site or sales office where a sales agent, using a computer connected to the computer system 140, can access the home shopper's registration information. However, the home shopper does not register again. Instead, the homes shopper's data is updated to reflect the home shopper's current visit. The home shopper does not need to repeat the complete registration process at subsequent visits to a sales office or home site after initially registering.

In a preferred embodiment, once a home shopper successfully completes the registration process, the designated home builder is informed that they have a new, interested home shopper. In another aspect of this invention, the home shopper management program automatically generates and electronically sends a thank you note to a home shopper who just completed registering. The home builder can then access the new, interested home shopper's information in the home shopper management program.

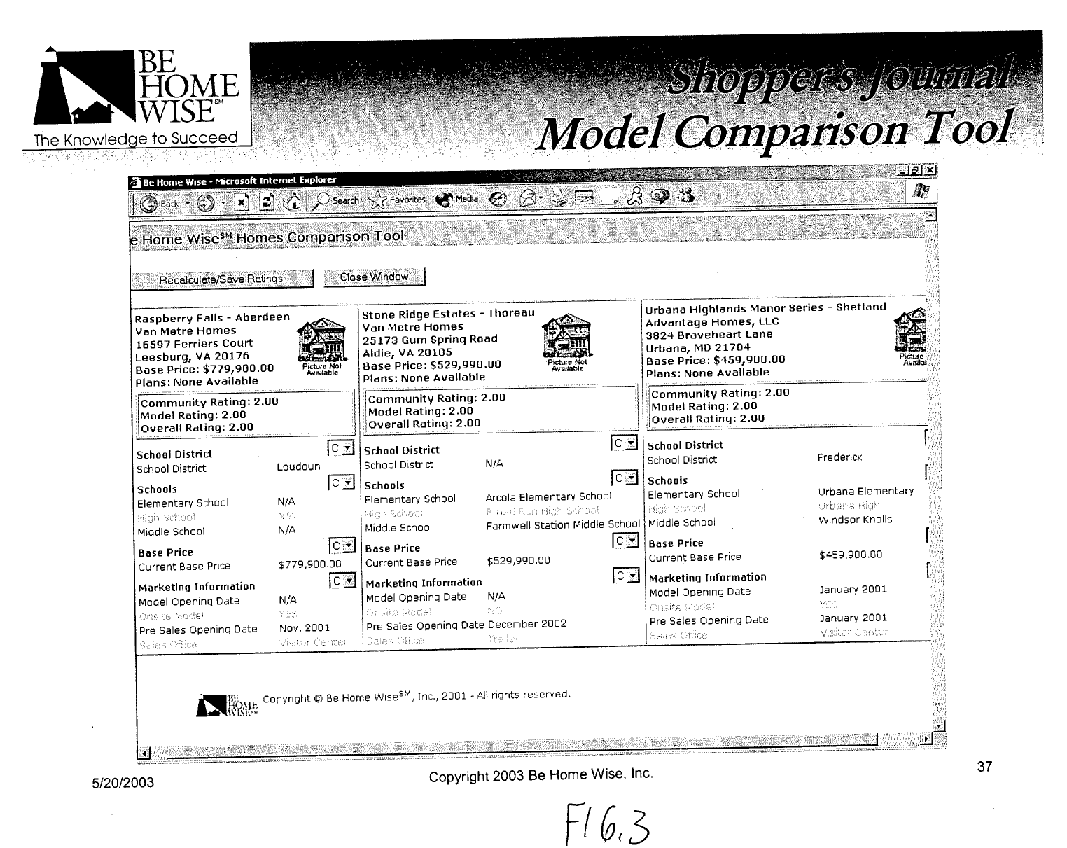

The home shopper's journal is a feature that tracks the home shopper's visits to home sites or sales offices. When a home shopper registers (or re-registers) at a home builder's home site or sales office, the registration information is retained by the computer system 140. A home shopper can log into the home shopper management program and have displayed all of the home sites or sales office that the home shopper has visited. In a preferred embodiment, the home shopper management program's display of a home shopper's visits enables a user to display information about the home, or housing community. For example, the home shopper can recall home model information. The home shopper management program also permits a home shopper to enter his own notes about the home, or community, which are not accessible by a homebuilder. As seen in FIG. 3, a home journal for a home shopper is displayed. Further, a home shopper can rate different characteristic features of the home and home site. The characteristics are pre-defined by the system and a home shopper applies a grade rating to these characteristics. For example, the home shopper chooses to rate the school system that the home is located in. In a preferred embodiment, the evaluation system is grade based, where A is the highest grade and D is the lowest grade.

Additionally, a home shopper can compare different homes. By displaying different homes visited by the home shopper side by side, a home shopper can quickly and easily view two (or more) different homes and see the home shopper's respective ratings from each. In an aspect of the invention, features such as home price, features, and appliances can be compared.

Using a computer with Internet access, a potential home shopper may register for information about new homes from a home builder. In is not uncommon that a home shopper can navigate to several different Internet locations to register with a home builder. Some of these locations may be non-home shopper management system locations, i.e., not a part of the home shopper management system 100. For example, the home builder may have an Internet presence, the home shopper may go to the home builder's website to register, or the newspaper may provide general listings for any home builder. Additionally, a home builder may be one of several builders in a community. The community may have a website that enables a home shopper to register for the community as a whole, or the website may enable a home shopper to designate a specific home builder to register for. Further, third parties may provide the opportunity for a home shopper to register for a home builder. A home shopper interested homes sold by a particular home builder, may register with a computer connected to the home shopper management program. However, a home shopper interested in a home builder may also register with another computer system that is not part of the home shopper management system 100. When a home shopper registers for a home of a home builder in a computer system that is not the computer system of the home builder, then the home shopper's registration must be forwarded to the home builder. Typically, the registration is e-mailed to the home builder. The home builder prints the emailed registration out and distributes it in the paper form. This distribution of the leads in paper form can delay the time for a sales person to follow up on the home shopper's registration. As the number of paper leads increases, so does the potential for lost sales due to the leads growing cold due to the delay of the sales person following up communication with the home shopper.

A home builder is generally interested in the registration information for all of his potential customers, i.e., home shoppers, being in the same computer system, preferably the home shopper management program. In a preferable embodiment of the invention, the home shopper management program collects registration information from other computer systems of home shoppers interested in a home builder who are not part of the home shopper management system 100. In this aspect of the invention, home shoppers' registrations are automatically collected from non-home shopper management system locations, e.g., web sites, and stored in the database of the home shopper management system 100. This is done, for example, by the home builder identifying locations, e.g., portals, web sites, or network servers, from which data should be collected. Further, this requires coordination between the other computer system, e.g., the non-home shopper management system, and the home shopper management program, so that the other computer system communicates with the home shopper management program and also provides the shopper's registration system to the home shopper management program.

For example, a user reading an electronic version of a newspaper on the Internet shops for a new home. The user enters characteristics of a home that he is shopping for, e.g., price range and location. In response to these characteristics, the electronic newspaper provides a list of home builders or communities with homes for sale, and the user selects one. If the user selects a home builder that is part of the home shopper management system, then the electronic newspaper provides a portal to the home shopper management system 100. Thus, the user registers directly with the home shopper management system 100. Thus, this aspect of the invention provides a universal gateway for gathering data from different websites and computer systems.

As indicated above, the home builder registers information about his organization and about his communities. Organizational information may include organization structure, employees, and employees' positions within the company. For example, the home builder indicates the names of his sales agents, and what communities they represent. The home builder also may indicate sales managers and other management personnel. Community information may include models, prices and availability. For example, a home builder has four communities, each having three models, each model having a unique name, number of bedrooms and bathrooms, and a respective square-footage.

A home builder accesses the home shopper management program to receive information about home shoppers that visit a sales office or home site of the home builder. As indicated above, several of the features of the home shopper management system 100 are directed towards assisting home builders to sell homes. One feature relates to the home shopper management system 100 evaluating the home shopper's responses to the registration questions.

In a preferred embodiment, several of the questions answered by the home shopper are used to rate the home shopper. This rating corresponds to the potential for the home builder to sell the home shopper a home. In a preferred embodiment, the rating process is dependant upon the answers to questions in the following three areas: “Contingency,” “Timeframe to Move,” and “Financing”. Each category is rated independently.

Timeframe to Move refers to the length of time a home shopper has been shopping for a new home. It is known how the length of time a home shopper has been looking for a new home affects the likelihood that the home shopper will actually buy a new home in the near future. A home shopper is rated depending on how long the home shopper has been shopping. In a preferred embodiment, for example, the home shopper is a strong prospect if he needs to move within the next three months. If the home shopper does not need to move until later than four months, then he is not a strong prospect.

Financing refers to the ability of the home shopper to purchase a home in the home builder's community. A home shopper's financing rating depends on the home shopper's income and the cost of the desired home. In a preferred embodiment, the home builder defines income ranges for home shoppers and a desired income range for a desired home. For example, a home builder sells a home for $200,000. The home builder defines the following income ranges: <$100,000, $100,000-$150,000, and >$150,000. The home builder designates the $100,000-$150,000 range as the desired range, and the other ranges as the undesirable ranges. Thus, if the home shopper's income is in the desired range, then he is a strong prospect. Thus, if the home shopper's income is not in the desired range, then he is not a strong prospect.

Contingency refers to whether a buyer's decisions or ability to buy a new home depends on another event. Contingencies can adversely affect the likelihood of a quick sale. Thus, a buyer with a contingency may be a cold or warm prospect. For example, a contingency could be having to first sell an existing home. As one would expect, having to sell another home first can adversely affect a buyer's ability to quickly purchase a new home. In a preferred embodiment, for example, the home shopper is a strong prospect if there are no contingencies. The home shopper is a not strong prospect if there are any contingencies.

Once ratings have been calculated for Contingency, Timeframe to Move, and Financing, then an overall rating is computed for the home shopper. For each rating in which the home shopper is a strong prospect, the home shopper is assigned a point. The overall rating is the sum of the assigned points assigned for each rating (i.e., Contingency, Timeframe to Move, and Financing), plus 1 point. The resulting value indicates a home shopper rating on a graded scale from “A”-“D” (where A is the hottest prospect and D is the coldest prospect corresponding from four to one total point). For example, if a home shopper is a strong prospect with respect to Contingency and Financing, but not Timeframe to Move, then the home shopper, would have two assigned points plus the one point, and therefore the home shopper would have an overall rating of 3 points, or a “B.”

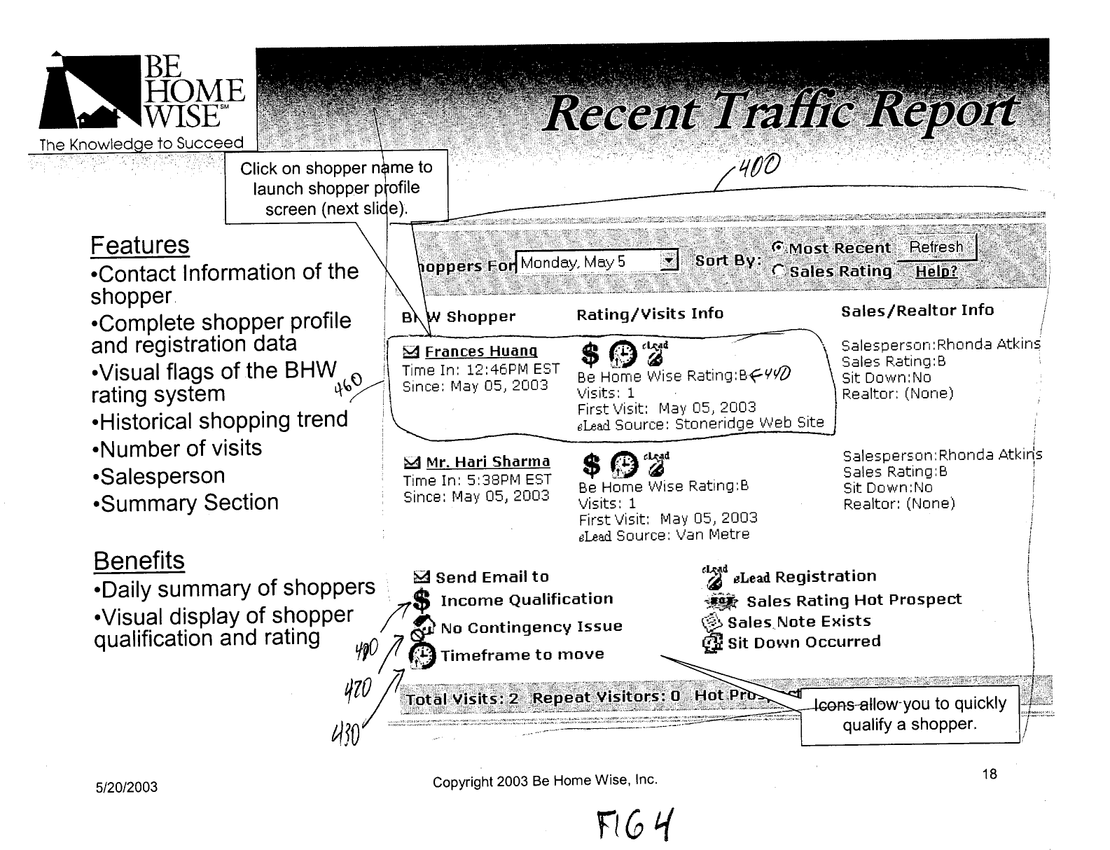

FIG. 4 shows an exemplary screen display of a home builder viewing recent home shopper visitors. After accessing the home shopper management program, the home builder can choose to have the home shopper's information displayed. As part of the display, graphical representations may be used to indicate the home shopper's rating for Contingency, Timeframe to Move, and Financing. As seen in FIG. 4 symbol 420 corresponds to a contingency issue, symbol 430 relates to timeframe to move, and symbol 410 corresponds to the home shopper's financing. For example, for home shopper 460 (“Frances Huang”), the income qualification symbol 410 (i.e., financing) and Timeframe to Move symbol 430 is displayed. Additionally, the shopper's rating is provided and displayed by symbol 440, which shows a “B” rating.

Another aspect of the present invention provides administrative and management tools for a home builder, and more specifically, a sales person, to increase their productivity. A contact management module is a tool, e.g., a computer program, for managing customer relations based on the data collected during the home shopper's registration process. The program is a set of follow-up actions that can either be pre-defined by the system or defined by the home builder (which may be modifications of the pre-defined systems). The program may have parameters that can be modified by the home builder. For example, a parameter may be a selection of home shoppers having particular features, like current income level.

Further, the contact management module can be used for administrative tasks: for example, a tickler for different types of events can be programmed. In this manner, the contact management module can be used to remind a sales person, or other user of the system, of some event (or the anniversary of some event). For example, a sales person indicates that a home shopper might be ready to buy in forty-five days, then the contact management module can be programmed to automatically remind the sales person in forty-five days of that date. In another aspect, a “to-do” list can be maintained for the sales persons. The to-do list may also include the ability to notate items to, for example, indicate the state of completeness of the task.

The contact management module may also be programmed to perform other administrative events, such as performing certain actions in response to another action. For example, the contact management module may be programmed to automatically generate and send an email to a home shopper who just completed a visit. Or, the contact management module may be programmed to generate and send holiday cards to some, or all, of the home shoppers. Further, the contact management module may be used in permissive marketing, where a home shopper has indicated an interest in receiving additional information about a product.

In another aspect of the invention, the home shopper management program provides pre-defined tools—“Hotsheets”—for analyzing home shopper information. In one aspect, the home shopper management program provides information about a home builder's home shoppers. In a preferred embodiment, the home shopper management program provides information about all the home shoppers in the home shopper management system without filtering home shopper information particular to a home builder.

As is known, there are many different database products, and programs, available to manage databases. One database management product is Microsoft's SQL server 2000. Microsoft also markets a database analysis tool—OLAP—which is part of Microsoft's product analysis services. In this aspect of the invention, the home shopper management program analyzes home shopper management system 100 data in real time and provides the analysis to designated computers of the home builder upon request. The designated computers are mostly likely part of the homebuilder's management office. The data is presented in a spreadsheet-like format, e.g., Excel format. Conventional use of OLAP has been in intranet situations, e.g., situations within a local or wide area network. However, in the present invention, the data is shared through the Internet by the home shopper management program, where the home shopper management program presents the information reports to the home builder's computer.

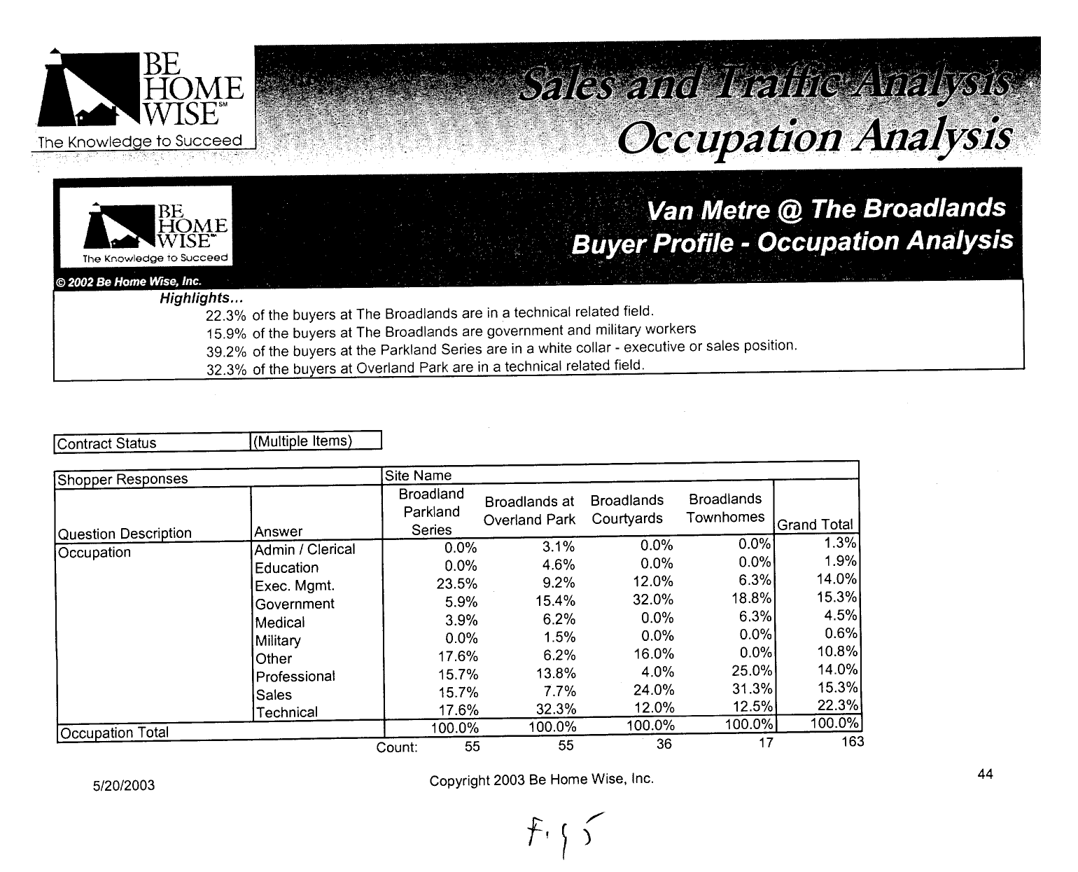

Hotsheets are pre-defined analysis reports that are derived from home shoppers' registrations and are based on Online Analytical Processing (“OLAP”). OLAP provides multi-dimensional view of data, i.e., a “cube” view that allows analyzing data in many different ways. Essentially, Hotsheets are instructions, indicating what data is to be analyzed, how it is going to be analyzed, and how it should be presented, i.e., how the information will be filtered. Analysis presented in typical spreadsheet format is flat, i.e., it is two dimensional, where an entry in a cell of the spreadsheet generally corresponds to the comparison of two different pieces of data. For example, a cell may reflect homes sales during March, 2003. Cube data is structured differently. A cell in a cube of data generally corresponds to more than two different pieces of data. For example, a cell in a data cube may represent the occupation of home shoppers and within the cell representing the different occupations. FIGS. 5-10 depicts different screen displays from reports generated by Hotsheets.

FIG. 5 shows a report generated from a predefined Hotsheet, where the analysis is focused on the occupation of the home shopper as it corresponds to home sites.

The report differentiates the analysis by the home shoppers' responses to the question regarding occupation, e.g., Admin/Clerical, Education, Exec. Mgmt. The report further differentiates the analysis by the different home sites of the home builder. As a result, the report indicates to the home builder the occupation of the buyers at the different home sites.

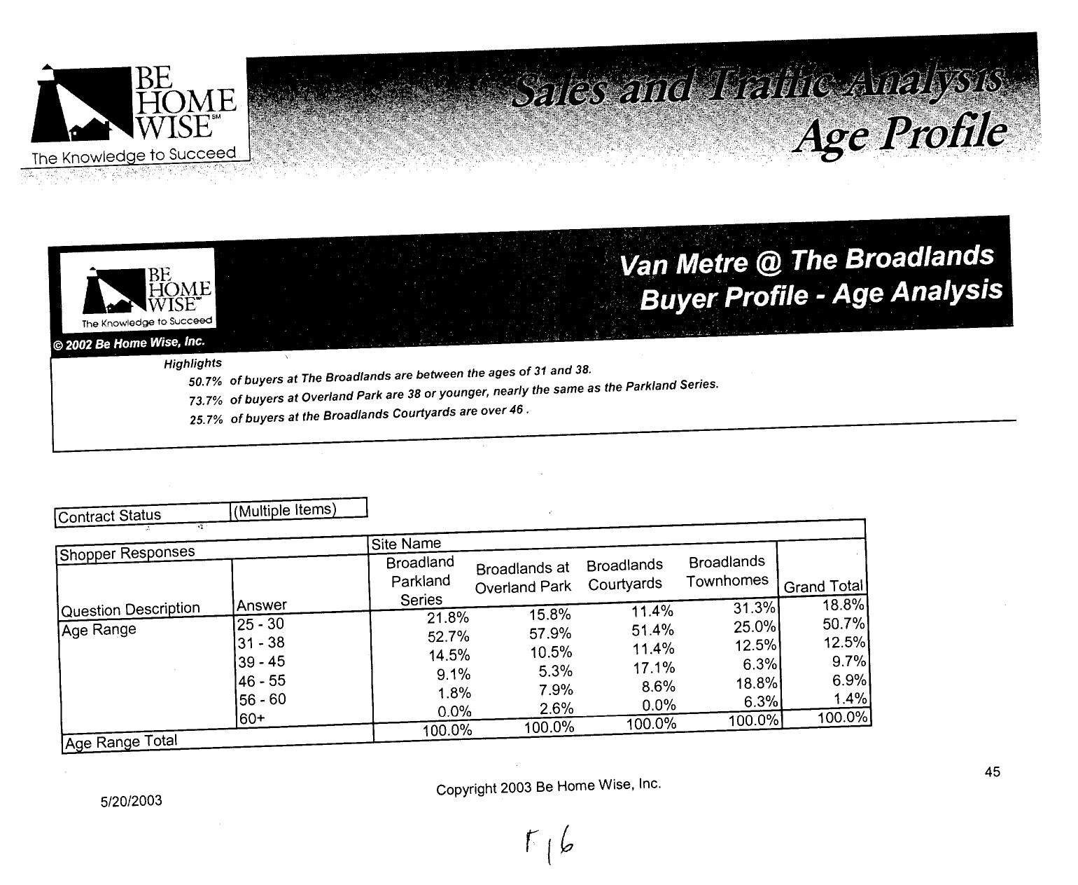

FIG. 6 shows a report generated from a predefined Hotsheet, where the analysis is focused on the age of the home shopper as it corresponds to home sites. The report differentiates the analysis by the home shoppers' responses to the question regarding Age Range, e.g., 25-30, 31-38, 39-45. The report further differentiates the analysis by the different home sites of the home builder. As a result, the report indicates to the home builder the age range of the buyers at the different home sites.

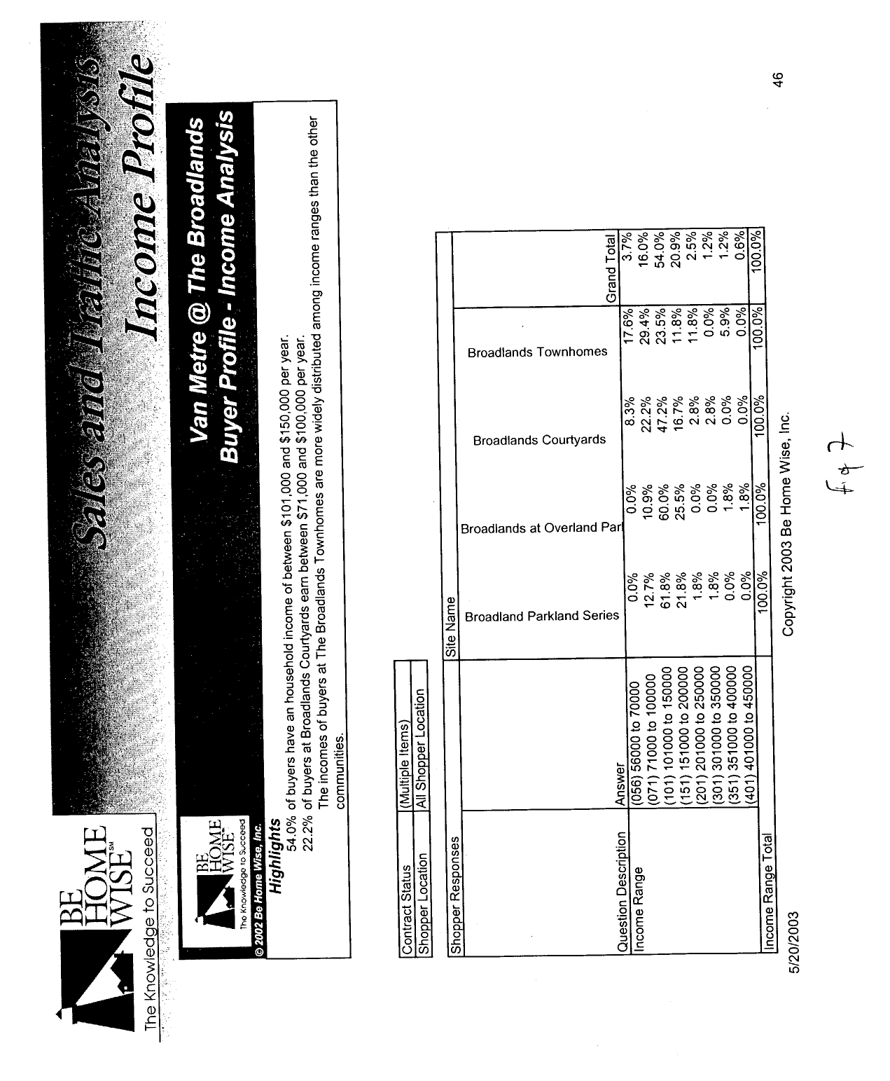

FIG. 7 shows a report generated from a predefined Hotsheet, where the analysis is focused on the income of the home shopper as it corresponds to home sites. The report differentiates the analysis by the home shoppers' responses to the question regarding Income Range, e.g., 56,000-70000, 71000-100000, 101000-150000. The report further differentiates the analysis by the different home sites of the home builder. As a result, the report indicates to the home builder the income range of the buyers at the different home sites.

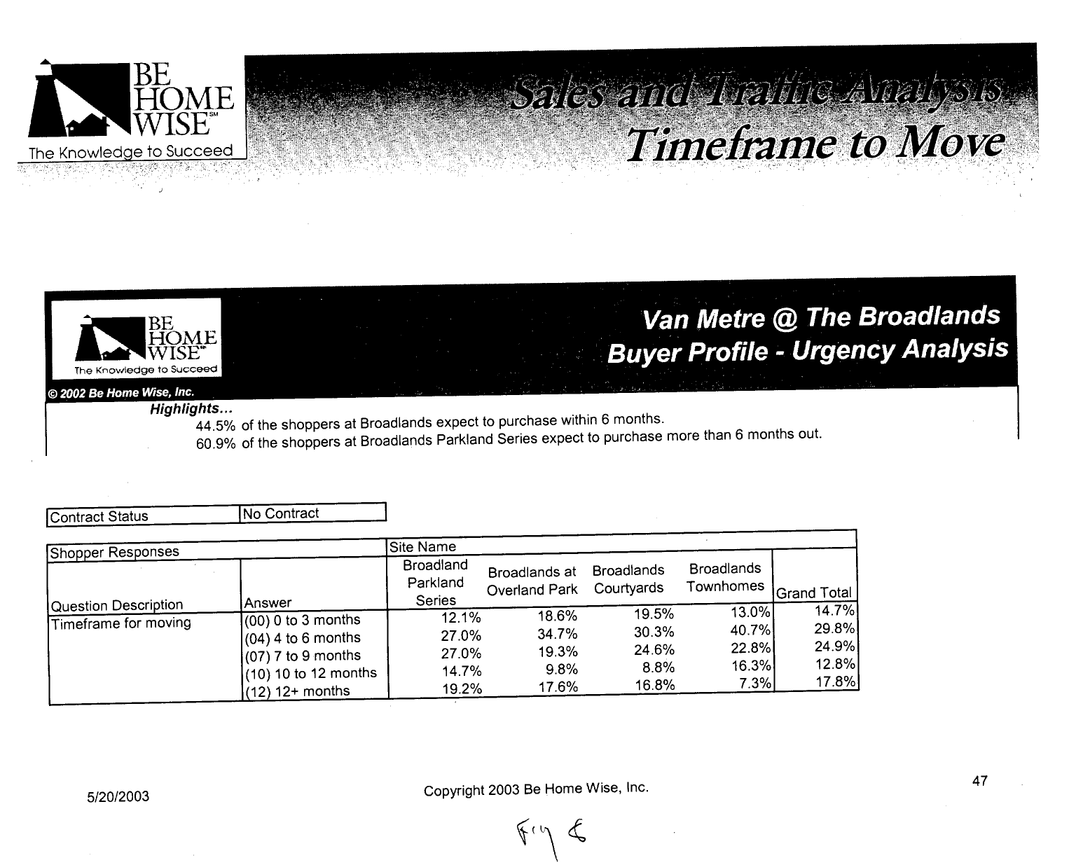

FIG. 8 shows a report generated from a predefined Hotsheet, where the analysis is focused on the urgency of the home shopper as it corresponds to home sites. The report differentiates the analysis by the home shoppers' responses to the question regarding Timeframe for Moving, e.g., 0-3 months, 4-6 months, 7-9 months. The report further differentiates the analysis by the different home sites of the home builder. As a result, the report indicates to the home builder the urgency of the home shoppers at the different home sites.

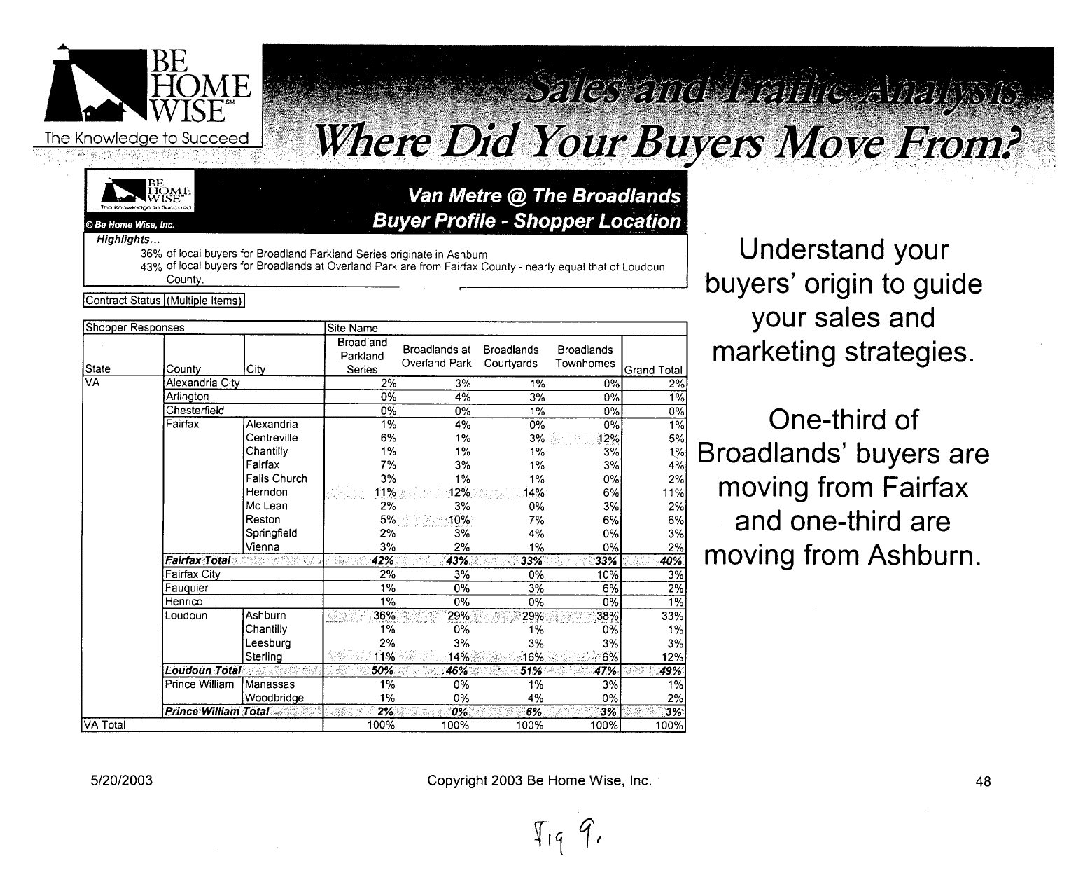

FIG. 9 shows a report generated from a predefined Hotsheet, where the analysis is focused on the previous residence of the home shopper as it corresponds to home sites. The report differentiates the analysis by the home shoppers' responses to the previous residences, indicating different states, counties, and cities. For example, in FIG. 9, the analysis is for Virginia, and further identifies counties and cities within the State. The report further differentiates the analysis by the different home sites of the home builder. As a result, the report indicates to the home builder where buyers at the different home sites previously lived.

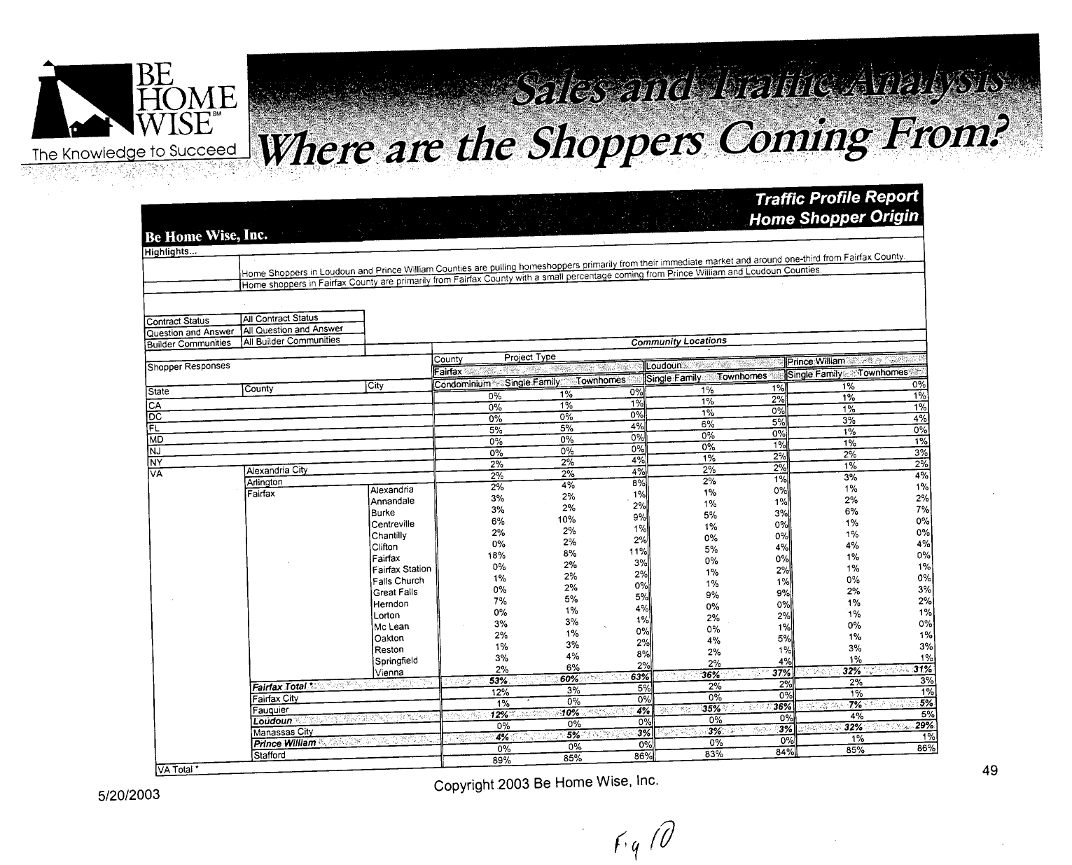

FIG. 10 shows a report generated from a predefined Hotsheet, where the analysis is focused on the residence of the home shopper as it corresponds to home sites. The report differentiates the analysis by the home shoppers' responses to the residences, indicating different states, counties, and cities. For example, in FIG. 10, the analysis is for all of the United States, and further identifies counties and cities. The report further differentiates the analysis by the different project sites and different project types of the home builder. As a result, the report indicates to the home builder where home shoppers at the different home sites are coming from.

Although the Hotsheet reports are described with reference to different exemplary embodiment in FIGS. 5-10, the invention is not so limited. Data in the home shopper management system is analyzed, and the results of the analysis is extracted and displayed in many approaches. These approaches can either be pre-defined as part of the home shopper management system, or can be defined at a different time, and by a different entity.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. Further, although described above in reference to home shoppers management system, the invention is not so limited. For example, the invention may be used for managing any system having prospective buyers and sellers. Accordingly, the invention is not limited by the foregoing description or drawings, but is only limited by the scope of the appended claims.

What is claimed as new and desired to be protected by Letters Patent of the United States is:

1. A method for managing a home shopper system, comprising the steps of:
accessing a central computer of a home shopper management system via a remote terminal;
registering in said home shopper management system, wherein said registering comprises:
submitting a plurality of responses to a plurality of questions; and
storing said plurality of responses to said plurality of questions as a record of a home shopper.

2. The method of claim 1, said accessing further comprising:
using the Internet to communicate with said central computer.

3. The method of claim 1, further comprising:
using a remote computer to respond to said plurality of questions, wherein said remote terminal is a terminal having Internet access.

4. The method of claim 1, wherein said remote terminal is a kiosk.

5. The method of claim 4, wherein said kiosk is located at a home builder location.

6. The method of claim 5, wherein said home builder location is a sales office.

7. The method of claim 5, wherein said home builder location is a home site.

8. The method of claim 1, wherein said plurality of questions being identifying information about a home shopper.

9. The method of claim 1, wherein said plurality of questions being identifying information about a home buying factors.

10. The method of claim 1, wherein said plurality of questions being identifying information about a home shopper visit.

11. The method of claim 2, further comprising:
re-registering in said home shopper management system.

12. The method of claim 11, further comprising:
responding to a second question, wherein said second question being home shopper identifying information.

13. The method of claim 12, further comprising:
retrieving said record of said home shopper.

14. The method of claim 13, wherein said second plurality of questions comprises:
responding to a third question, wherein said third question being information about a second home shopper visit.

15. The method of claim 14, further comprising:
submitting responses to said second and third questions.

16. The method of claim 15, further comprising:
storing said second and third questions as part of said record of said home shopper.

17. The method of claim 1, wherein said plurality of questions being a standardized set of questions.

18. A method for managing a home shopper system, comprising the steps of:
accessing a central computer of a home shopper management system via a remote terminal;
retrieving a home shopper journal of a home shopper;
viewing said home shopper journal; and
storing said home shopper journal.

19. The method of claim 18, further comprising:
rating characteristics of a home.

20. The method of claim 18, further comprising:
editing personal notes about a home.

21. The method of claim 18, further comprising:
comparing a home with another home.

22. A method for managing a home shopper system, comprising the steps of:
collecting home shopper information through a non-home shopper management system computer, wherein a home shopper management system computer communicates with said non-home shopper management system to transfer said home shopper information to said home shopper management system computer.

23. The method of claim 22, further comprising:
storing said home shopper information as a record of a home shopper in said home shopper management system.

24. A method for managing a home shopper system, comprising the steps of:
retrieving a record of a home shopper from a home shopper management system computer; and
rating said home shopper based on said record of said home shopper.

25. The method of claim 24, wherein said rating further comprises:
rating said home shopper based on a first characteristic.

26. The method of claim 25, wherein said first characteristic corresponds to contingencies.

27. The method of claim 25, wherein said rating further comprises:
rating said home shopper based on a second characteristic.

28. The method of claim 27, wherein said second characteristic corresponds to income.

29. The method of claim 27, wherein said rating further comprises:
rating said home shopper based on a third characteristic.

30. The method of claim 30, wherein said third characteristic corresponds to Timeframe to Move.

31. The method of claim 24, wherein said rating further comprises:
rating said home shopper based on a fourth characteristic.

32. The method of claim 30, wherein said fourth characteristic corresponds to Timeframe to Move, income and contingencies.

33. A method for managing a home shopper system, comprising the steps of:
retrieving a record of a home shopper from a home shopper management system computer;
determining if a task should be done by a home builder wherein said task is based upon said record of a home shopper; and
providing said task to said home builder.

34. The method of claim 33, wherein said task is a follow-up task.

35. The method of claim 33, wherein said task is a to-do list.

36. The method of claim 33, wherein said task comprises:
communications with said home shopper.

37. A method for managing a home shopper system, comprising the steps of:
retrieving a record of a home shopper from a home shopper management system computer; and
displaying said record of said home shopper.

38. The method of claim 37, further comprising:
editing said record.

39. The method of claim 38, further comprising:
saving said edited record of said home shopper in said home shopper management system computer.

40. A method for managing a home shopper system, comprising the steps of:
retrieving a plurality of records of home shoppers from a home shopper management system computer; and
preparing a report from said plurality of records based on a pre-defined filtering parameter.

41. The method of claim 40, further comprising:
transforming said plurality of records into a multi-dimensional representation of data.

42. The method of claim 41, wherein said multi-dimensional representation of data is a datacube.

43. The method of claim 41, wherein said a pre-defined filtering parameter is a hotsheet.

44. A method for managing a home shopper system, comprising the steps of:
registering in a home shopper management system;
retrieving a record of home shopper from said home shopper management system;
rating said home shopper based on said record of said home shopper; and
determining if a task should be done by a home builder wherein said task is based upon said record of a home shopper.
